(19) United States
(12) Patent Application Publication
(10) Pub. No.: US 2006/0278330 A1
(43) Pub. Date: Dec. 14, 2006

(54) Method for the embossing treatment of multi-layer film

(75) Inventor: Kwi-Man Kim, Asan-si (KR)

Correspondence Address: BIRCH STEWART KOLASCH & BIRCH, PO BOX 747, FALLS CHURCH, VA, 22040-0747, US

(73) Assignee: Hana Cobi., Ltd. and MG Chemicals

(21) Appl. No.: 11/509,668

(22) Filed: Aug. 25, 2006

Related U.S. Application Data
(63) Continuation of application No. PCT/KR05/00011, filed on Jan. 4, 2005.

(30) Foreign Application Priority Data
Feb. 27, 2004 (KR) 10-2004-0013435

(51) Int. Cl. B32B 38/06; B44C 3/08; B29C 47/06; B29C 47/00

(52) U.S. Cl. 156/220; 156/243; 156/244.24

(57) ABSTRACT

The present invention relates to a method of embossing a multi-layer film. In the method of embossing the multi-layer film using an embossing apparatus is used comprising a material supply unit for supplying at least one resin material, a T-plate for discharging the individually supplied materials into a film, a cooling roller for cooling and conveying for embossing a surface of the film the film discharged from the T-plate, an embossing roller conveyed from the cooling roller positioned at a predetermined interval from the T-plate and a transfer roller for transferring the embossed film, the cooling roller is formed to have a smooth outer surface so that one side of the film to be manufactured has high printability and transparency, the transfer roller conveys the film from the cooling roller and is positioned at a predetermined interval from the T-plate opposite the side where the embossing roller engages film conveyed from the cooling roller, and a vacuum suction chamber is longitudinally formed at the position where the film discharged from the T-plate comes into contact with the cooling roller to prevent entry of air or impurities between the cooling roller and the film, whereby the resin materials having different deformation temperatures supplied from the material supply unit are disposed through the T-plate into the film having a three-layer structure which includes a base film layer to be in contact with the cooling roller, an embossing film layer on which embossments are to be formed by bringing the embossing film layer into contact with the embossing roller and an adhesive film layer for adhesion between the base film layer. The embossing film layer, and the embossments are formed only on the embossing film layer of the film using the embossing roller which engages the film conveyed from the cooling roller, after which the film is cooled by the cooling roller and then separated therefrom through the transfer roller.

### TECHNICAL FIELD

The present invention relates, in general, to an apparatus for embossing a multi-layer film. The invention describes an embossing apparatus that uses an irregularly surfaced embossing roller to produce multi-layer film for vacuum packaging that is soft and highly transparent character sic, while being durable and flexible.

### BACKGROUND ART

Generally, an embossed multi-layer film has been developed to facilitate vacuum packaging which helps to protect packaged objects by the cushioning action of embossments thereof while maintaining the objects packaged therein in a vacuumized state. It also has been used variously for other different purposes.

The method of preparing such a film is classified into two types: A blown method for inflating a molten flexible synthetic resin by blowing air into the flexible synthetic resin, and a casting method using a plurality of shaping rollers. Particularly, in the latter casting method, two methods are representatively used, the first being a method comprising the steps of primarily preparing the film with smooth surfaces, heating the prepared film, and then passing the heated film between embossing rollers each having a plurality of embossing irregularities on its outer surface, secondly, thereby providing the film with embossed surfaces, and a method comprising the steps of passing the film with smooth surfaces, which is prepared by the above method, between general plain rollers, and then supplying a resin material, extruded from a T-plate, to the upper or lower surface of the film while compressing the resin material disposed into the film, thereby achieving attachment of the resin material to the film and embossment of the resin material.

However, the above methods are disadvantageous because the synthetic resin is crystallized and cured by secondary heating of the already prepared and shaped film, resulting in lowered durability and flexibility of the film. Thus, noise occurs when such a film is folded or crumpled, and also, cracks and pin holes are generated at the folded portions of the film, and the adhesion of the film becomes poor due to entry of impurities and air.

To solve the above problems, various methods have been proposed exemplified by Japanese Patent Laid-open Publication No. Hei. 10-100234 and Korean Patent Laid-open Publication No. 2003-0022226.

Japanese Patent Laid-open Publication No. Hei. 10-100234 discloses a method of manufacturing an embossed resin sheet using an embossing apparatus comprising a die for supplying a resin material, a cooling drum for cooling the resin extruded from the die, an embossing roll for embossing the resin extruded from the die by pressing, and a guide roll for transferring and discharging the embossed resin, and an electrostatic application electrode for bringing the resin extruded from the die into close contact with the surface of the cooling drum. In this method the molten thermoplastic resin sheet to be extruded from the die onto the cooling drum comes into close contact with the surface of the cooling drum using the electrostatic application electrode, and then, the molten thermoplastic resin sheet on the surface of the cooling drum is pressed by means of the embossing roll to form the embossments on the resin sheet.

In addition, Korean Patent Laid-open Publication No. 2003-0022226 discloses a method of manufacturing an embossed multi-layer film using an embossing apparatus comprising a material supply unit for supplying at least one synthetic resin material, a T-plate for discharging the individually supplied materials into a film having at least one layer, an embossing roller for embossing the surface of the film discharged from the T-plate and a transfer roller for cooling and transferring the embossed film, in which the film discharged from the T-plate is passed through the embossing roller having suction holes acting to apply suction force toward inner hollow portions thereof, whereby the film is sucked into the suction holes of the embossing roller to form a plurality of protrusions on the film having shapes corresponding to those of the suction holes.

However, the above method is disadvantageous because the embossments comprising the plurality of protrusions having shapes corresponding to those of the suction holes of the embossing roller may be unclearly formed or non-uniformly formed, depending on the suction force or operating conditions, when they are formed on the film using the embossing roller.

Moreover, upon suction, pin holes, in which the film is partially perforated may be formed, or worse, the film may partially burst and have such low quality that it is unsuitable for use in vacuum packaging.

### DISCLOSURE OF THE INVENTION

Accordingly, the present invention has been made to overcome the above problems occurring in the related art. An object of the present invention is to provide a method of embossing a multi-layer film, in which an additional heating process is omitted upon formation of embossments, so as to maximally prevent the film from curing due to crystallization and avoid the problems of non-uniform formation of the embossments, partial bursting, dampness, and pin holes.

Another object of the present invention is to provide a method of embossing a multi-layer film, in which the embossments having a predetermined shape are uniformly formed.

A further object of the present invention is to provide a method of embossing a multi-layer film, in which one surface of the film is formed to be smooth to increase printability and transparency, and to decrease defectiveness rate, thus increasing the quality of end products.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing an embossing apparatus for a multi-layer film, according to the embodiment of the present invention;

FIG. 2 is a sectional view showing the embossing apparatus in use, according to the embodiment of the present invention;

FIG. 3 is a schematic view showing a process of embossing a multi-layer film, according to the embodiment of the present invention; and

FIG. 4 is a view showing an embossing roller, according to the embodiment of the present invention.

### BEST MODE FOR CARRYING OUT THE INVENTION

In order to achieve the above objects, the present invention provides a method of embossing a multi-layer film using an embossing apparatus for the multi-layer film comprising a material supply unit for supplying at least one resin material, a T-plate for discharging the individually supplied materials into a film having at least one layer, a cooling roller for cooling and conveying the film discharged from the T-plate, an embossing roller for embossing the surface of the film, and a transfer roller for transferring the embossed film.

In the present invention, the heated fluid ma which is discharged from the T-plate, is rapidly cooled on the side where it comes into contact with the cooling roller, whereas it is cooled relatively slowly on the other side where it comes into contact with the embossing roller. Thereby, the side of the film in contact with the cooling roller is formed to be smooth by the smooth outer surface of the cooling roller, while the other side of the film in contact with the embossing roller is easily embossed by the compression of the embossing roller.

To heat the resin material at a high temperature in the T-plate and then discharge the heated resin material therefrom, The barrel and screw of an extruder are heated to 200-300° C. using an electrical heater and the screw is rotated to push and discharge the resin material into the T-plate.

Also, a plurality of protrusions are formed on the outer surface of the embossing roller. Thus, when the film discharged from the T-plate is cooled, it is compressed by the compression force of the embossing roller to form embossments on the film. Thereby, the possibility of crystallizing and curing the resin material due to repeated heating is minimized by not requiring additional heating. Hence, the method of the present invention is advantageous because it enhances producibility and lowers embossing treatment costs, while obtaining high quality products.

The multi-layer film of the present invention is formed into two layers or more. It is preferable that the film be formed to have a three-layer structure.

The three-layer structure of the multi-layer film includes a base film layer formed out of a resin having a high cooling rate and air-proofness, an embossing film layer formed out of a resin having a low cooling rate and high tensile strength and tear strength while being embossable, and an adhesive film layer formed out of an adhesive resin for adhesion between the base film layer and the embossing film layer.

The base film layer may be formed out of any resin material having high crystallinity, tension resistance and gas-proofness, which is exemplified preferably by polyamide based resin, and more preferably nylon.

The embossing film layer may be formed out of any resin material having low crystallinity, which is exemplified preferably by LDPE (Low Density Polyethylene) or LLDPE (Linear Low Density Polyethylene), and more preferably PE (Polyethyene).

The adhesive film layer may be formed out of any adhesive resin, which is exemplified preferably by maleic anhydride.

In the present invention, the outer surface of the cooling roller is formed to be smooth, and thus, one surface of the film is prepared to be smooth to increase printability and transparency of the film. Further, it enables the rate of defects such as pin holes or partial bursting to be lowered and increase the quality of end products.

The embossments formed on the film are variously shaped depending on the shapes of the protrusions formed on the outer surface of the embossing roller, and may further include logos, such as letters, if desired.

In addition, the embossed films may be easily manufactured in accordance with various embodiments while not being limited to use of the cylindrical embossing roller having protrusions by those skilled in the art.

Hereinafter, a detailed description will be given as a preferable aspect according to the embodiment of the present invention, with reference to the appended drawings.

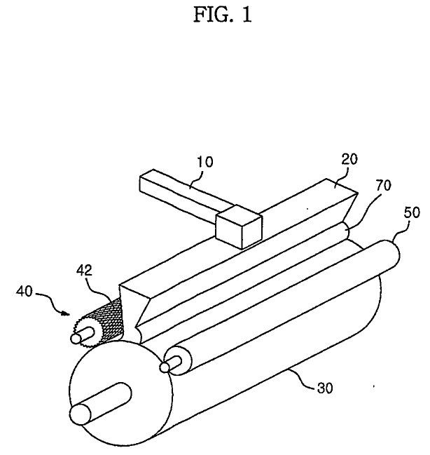

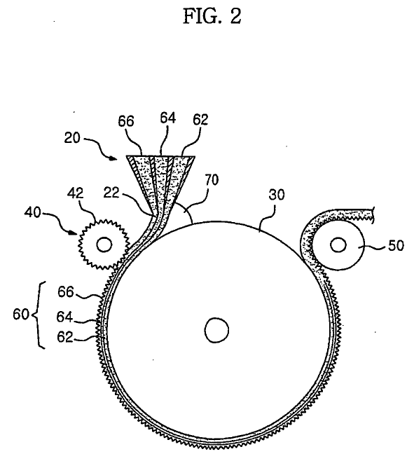

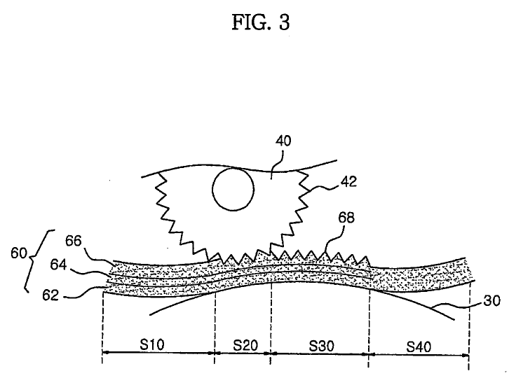

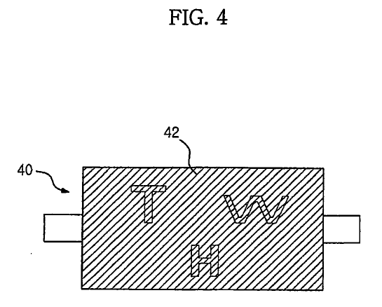

FIG. 1 is a perspective view showing the embossing apparatus for the multi-layer film according to the embodiment of the present invention, and FIG. 2 is a view showing the above apparatus in use according to the embodiment of the present invention. Also, FIG. 3 is a view showing a process of forming the embossments, according to the embodiment of the present invention, and FIG. 4 is a view showing the embossing roller used in the present invention.

The embossing apparatus for the multi-layer film of the present invention includes a material supply unit 10 for supplying at least one resin material, a T-plate 20 for discharging the individually supplied materials into a film having at least one layer, a cooling roller 30 for cooling and conveying the film 60 discharged from the T-plate 20, an embossing roller 40 for embossing the surface of the film 60, and a transfer roller 50 for transferring the embossed film 60.

The resin material is provided in various kinds, depending on the number of layers constituting the multi-layer film 60 of the present invention. A multi-layer film 60 having two layers or more is formed.

The film 60 having a multi-layer structure includes a base film layer 62 formed out of a resin having a high cooling rate and oxygen-proofness, an embossing film layer 66 formed of a resin having a low cooling rate, high tensile strength and tear strength while being embossable, and an adhesive film layer 64 formed out of an adhesive resin for adhesion between the base film layer 62 and the embossing film layer 66.

Any resin may be used for the base film layer 62 so long as it has high crystallinity, tension resistance and gas-proofness, which is preferably exemplified by a polyamide based resin, and more preferably nylon.

Any resin may be used for the embossing film layer 66 so long as it has low crystals, which is preferably exemplified by LDPE (Low Density Polyethylene) or LLDPE (Linear Low Density Polyethylene), and more preferably PE (Polyethylene).

Any resin may be used for the adhesive film layer 64 so long as it has adhesion, which is preferably exemplified by maleic anhydride.

Moreover, the T-plate 20 is provided at a lower portion thereof with an outlet 22 longitudinally exhaling to discharge the resin materials into a film, whereby the resin materials can be discharged into the film in accordance with a general co-extrusion process.

The outlet 22 of the T-plate 20 is to be adjacent to the cooling roller 30.

The outer surface of the cooling roller 30 is formed to be smooth so as to increase the printability and transparency of one surface of the film 60.

One side of the heated resin material discharged from the T-plate 20, which comes into contact with the cooling roller 30, is rapidly cooled, whereas the other side thereof coming into contact with the embossing roller 40 is cooled relatively slowly. Therefore, the base film layer 62 which is the side of the film in contact with the cooling roller 30 is formed to have a smooth surface, while the embossing film layer 66 which is the other side of the film in contact with the embossing roller 40 is still flexible in the state of being non-crystallized and is thus easily embossed by the compression of the embossing roller 40.

On the outer surface of the embossing roller 40, protrusions 42 are formed corresponding to the embossments 68 to be formed on the film 60. The embossing roller 40 is formed to be engaged with the cooling roller 30 at a position where the embossing film layer 66 of the film 60 is not yet cured while the base film layer 62 thereof discharged from the T-plate 20 is cooled and cured.

Therefore, while the film 60 discharged from the T-plate 20 is passed between the cooling roller 30 and the embossing roller 40, the protrusions 42 formed on the outer surface of the embossing roller 40 act to compress the embossing film layer 66 of the film 60 so as to emboss only the embossing film layer 66 of the film 60.

The embossments 68 to be formed on the film 60 may be variously shaped in accordance with the shapes of protrusions 42 formed on the outer surface of the embossing roller 40. As shown in FIG. 4, the protrusions 42 may be formed to include logos, such as letters, if required, whereby letters and/or logos may be further provided on the film 60.

If, when the film 60 is embossed by the compression of the embossing roller 40, the fluidity of the film 60 determined by the temperature thereof is not well balanced to the compression force, the embossments 68 are incompletely formed or the embossments 68 may be formed in the base film layer 62 of the film 60. Thus, it is preferable that the embossing process be performed carefully.

At this point, the fluidity of the film 60 is determined according to the temperature of the film 60 heated in the T-plate 20. By controlling the compression force of the embossing roller 40 in the range of 0-50 kg/m² the size of the embossments 68 formed on the base film layer 62 of the film 60 can be controlled.

The transfer roller 50 is positioned at a predetermined interval from the T-plate 20 opposite the side Were the embossing roller 40 engages film conveyed from the cooling roller 30. The transfer roller 50 is rotated in the state of engaging the film in contact with the cooling roller 30 so that the film is in close contact with the outer surface of the cooling roller 30 between the transfer roller 50 and the embossing roller 40.

At the position where the film 60 discharged from the outlet 22 of the T-plate 20 comes into contact wiht the cooling roller 30, a vacuum suction chamber 70 is longitudinally formed to prevent entry of air or impurities between the cooling roller 30 and the film 60 so as not to cause defects.

Due to the suction chamber 70, the film 60 can be in close contact with the cooling roller 30.

In order to easily cool the film 60 by appropriately cooling and controlling the temperature of the cooling roller 30 which becomes heated due to the repeated operation, the T-plate 20 is spaced by a predetermined interval from the transfer roller 50, so that the cooling roller 30 is partially exposed to external air.

The transfer roller 50 functions not only to guide the discharge of the film 60 from the cooling roller 30 but also control the length of the film 60 to be cooled by the cooling roller 30, by changing the spacing between the embossing roller 40 and the trans roller 50.

Thus, it is preferable that the angular cooling range of the film 60 in close contact with the cooling roller 30 between the embossing roller 40 and the transfer roller 50 be formed more than 180° with respect to a central axis of the cooling roller 30.

The cooling roller 30 and the embossing roller 40 for use in formation of the embossments 68 can act to form the embossments 68 on the film 60, even if their positions are reversed.

According to the embodiment of the present invention, the process of forming the embossments 68 on the multi-layer film is as follows.

In the film discharging step S10, a multi-layer film comprising the base film layer 62 the embossing film layer 66 on which the embossments 68 are to be formed, and the adhesive film layer 64 for adhesion between the base film layer 62 and the embossing film layer 66 is discharged through the outlet 22 of the T-plate 20 where the supplied plurality of resin materials having crystallinities are heated to be melted; in the providing step S20, the discharged film 60 adheres to the cooling roller 30; in the embossments forming step S30, the embossments 68 are formed only on the embossing film layer 66 of the film 60 using the embossing roller 40 having a plurality of protrusions 42 on the outer surface thereof; in the cooling step S40, the film 60 having the embossments 68 is conveyed the film 60 along the cooling roller 30 in the state of being in close contact with the outer surface of the cooling roller 30; in the separating step S50, the film 60 having the embossments 68 is separated from the cooling roller 30 by means of the transfer roller 50. The above steps progress in sequence.

The base film layer 62 is formed out of a polyamide based resin having high crystallinity, tension resistance and air-proofness.

The embossing film layer 66 is formed out of any kind selected from among LDPE (Low Density Polyethylene), LLDPE (Linear Low Density Polyethylene) and PE (Polyethylene), each of which has low crystallinity.

The adhesive film layer 64 is formed out of maleic anhydride having adhesion.

In the providing step (S20), the film 60 is forcibly provided on the cooling roller 30 by the rotation force of the cooling roller 30. At this time, it is preferable that the film 60 be in close contact with the cooling roller 30 so that no space is formed.

In the embossments forming step (S30), the embossments 68 are formed by bringing the embossing film layer 66 of the multi-layer film 60 discharged from the T-plate 20 into contact with the embossing roller 40 before being cooled while the base film layer 62 of the firm 60, in contact with the cooling roller 30, is cooled.

In the embossments forming step (S30), to form the embossments 68 further including various letters and/or logos on the film 60, the embossments 68 are formed using the embossing roller 40 provided with protrusions 42 having various letters and/or logos.

In the embossments forming step (S30), when the embossments 68 are formed by the compression of the embossing roller 40, they may be incompletely formed or may also be formed in the base film layer 62 of the film 60 in the case where the fluidity of the film 60 depending on the temperature thereof is not well balanced to the compression force. Thus, it is preferable that the above step be performed carefully.

To appropriately control the temperature of the cooling roller 30 which determines the formation of the embossments 68, an air cooling process using external air is desirably employed, because it does not require additional power or apparatus. In some cases, an additional cooling device is provided to farther increase cooling efficiencies.

Therefore, the embossed multi-layer film produced by the above process is suitable for use in vacuum packaging various foods for protecting packaged objects due to the cushioning action of the embossments 68 thereof while maintaining the objects packaged therein in a vacuumized state. Further, the above film may be used to package all articles requiring vacuum packaging, such as mechanical components, products to be stored for long periods, products to protect semiconductors, products having tensile strength, etc.

As described above, the present invention provides a method of embossing a multi-layer film. When the multi-layer film having high viscosity due to being heated is cooled in the state of being in close contact with the cooling roller having the smooth outer surface, only one surface of the film is embossed by the compression force of the embossing roller, and the other surface thereof is formed to be smooth and transparent. Thereby, the smooth surface of the film having embossments is easily printed with various logos and letters. In addition, in the cases where the film is used for vacuum packaging, the packaged objects can be easily checked, and the defect rate of the film decreases, thus obtaining end products of high quality.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within meets and bounds of the claims, or equivalence of such meets and bounds are therefore intended to be embraced by the claims.

1. A method of embossing a multi-layer film using an embossing apparatus for the multi-layer film comprising a material supply unit for supplying at least one resin material, a T-plate for discharging the individually supplied materials into a film, a cooling roller for cooling and conveying the film discharged from the T-plate, an embossing roller for embossing a surface of the film conveyed from the cooling roller positioned at a predetermined intervalfi-om the T-plate for embossing a surface of the film, and a transfer roller for transferring the embossed film, the method comprises the steps of:
discharging a multi-layer film comprising the base film layer the embossing film layer on which the embossments are to be formed, and the adhesive film layer for adhesion between the base film layer and the embossing film layer which is discharged through the outlet of the T-plate where the supplied plurality of resin materials having different crystallinities are heated to be melted onto the cooling roller,;
providing the discharged film on the cooling roller;
forming the embossments only on the embossing film layer of the film using the embossing roller having a plurality of protrusions on an outer surface thereof;
cooling the film on which the embossments are formed while conveying the film along the cooling roller in the state of being in close contact with the outer surface of the cooling roller; and separating the film on which the embossments are formed from the cooling roller by means of the transfer roller.

2. The method according to claim 1, wherein the base film layer is formed out of a polyamide based resin having high crystallinity, tension resistance and gas-proofness.

3. The method according to claim 1, wherein the embossing film layer is formed out of any one selected from among LDPE (Low Density Polyethylene), LLDPE (Linear Low Density Polyethylene)and PE (polyethylene), each of which has low crystallinity.

4. The method according to claim 1, wherein the adhesive film layer is formed out of maleic anhydride having adhesion.

5. The method according to claim 1, wherein the forming of the embossments is performed by bringing the embossing film layer of the multi-layer film discharged from the T-plate into contact with the embossing roller to form the embossments thereon before cooling the embossing film layer of the multi-layer film while cooling the base film layer of the multi-layer film in contact with the cooling roller.

6. The method according to claim 1 or 5, wherein the forming of the embossments is performed using the embossing roller on which the protrusions are shaped to have various letters and/or logos, so that the embossments formed on the film further include various letters and/or logos.

7. The method according to claim 1, wherein the entry of air or impurities between the cooling roller and the film is prevented by use of a vacuum suction chamber formed at the position where the film fed from the T-plate comes into contact with the cooling roller.

8. A multi-layer film for use in vacuum packaging, manufactured by the method of claim 1.
